(19) United States
(12) Patent Application Publication
(10) Pub. No.: US 2026/0246364 A1
(43) Pub. Date: Aug. 20, 2026

(54) POWER CONVERTER AND VEHICLE AUXILIARY POWER SUPPLY

(71) Applicant: Mitsubishi Electric Corporation, Chiyoda-ku, Tokyo (JP)

(72) Inventors: Yoichi FUKUDA, Tokyo (JP); Shinichi MATSUMOTO, Tokyo (JP); Osamu ARAI, Tokyo (JP); Kouhei KARASAWA, Tokyo (JP); Akihide TOMOMATSU, Tokyo (JP)

(73) Assignee: Mitsubishi Electric Corporation, Chiyoda-ku, Tokyo (JP)

(21) Appl. No.: 18/876,728

(22) PCT Filed: Jun. 28, 2022
(86) PCT No.: PCT/JP2022/025825

§ 371 Date: Dec. 19, 2024

(51) Int. Cl. H02M 1/12; B60L 1/00; H02M 1/00

(52) U.S. Cl. CPC H02M 1/126; B60L 1/00; H02M 1/0009; B60L 2200/26; B60L 2210/40

(57) ABSTRACT

A power converter includes: a three-phase inverter; and a controller that controls operation of the three-phase inverter. The three-phase inverter converts input power into three-phase alternating-current power, and supplies the converted three-phase alternating-current power to a load via an alternating-current output filter including an ACL and an ACC. The controller estimates a capacitance of each phase of the ACC based on information on a three-phase voltage and information on a three-phase first current, the three-phase voltage being a voltage at each of connection points between the ACL and the ACC, the three-phase first current flowing between the three-phase inverter and each of the connection points.

### FIELD

The present disclosure relates to a power converter that converts input power into alternating-current power and supplies the alternating-current power to a load, and a vehicle auxiliary power supply that includes the power converter and supplies power to a load installed on a railway vehicle.

### BACKGROUND

A conventional vehicle auxiliary power supply is exemplified by, for example, the vehicle auxiliary power supply disclosed in Patent Literature 1 below. In the vehicle auxiliary power supply described in Patent Literature 1, a pulse width nodulation (PWM) converter is connected to an output end of a main transformer, and a three-phase inverter is connected to an output end of the PWM converter. The main transformer transforms an alternating current input from an alternating-current overhead line, and outputs the transformed alternating current. Furthermore, an alternating-current output filter is connected to an output end of the three-phase inverter. The alternating-current output filter is for removing harmonic components included in an output voltage of the three-phase inverter.

### CITATION LIST

### Patent Literature

Patent Literature 1: Japanese Patent No. 4391339

### SUMMARY OF INVENTION

### Problem to be Solved by the Invention

In a vehicle auxiliary power supply, an alternating-current output filter includes an alternating-current filter capacitor. At the time of maintenance of the vehicle auxiliary power supply, the alternating-current filter capacitor is also inspected. During this inspection, the capacitance of the alternating-current filter capacitor is measured. For these measurements, it is necessary to remove the alternating-current filter capacitor from the vehicle auxiliary power supply, so that time-consuming work is forced. In order to measure the capacitance of the alternating-current filter capacitor without removing the alternating-current filter capacitor, it is necessary to measure a current flowing through the alternating-current filter capacitor. However, providing a current sensor dedicated to an alternating-current filter capacitor leads to an increase in the number of components. For this reason, there has been a demand for a method for measuring the capacitance of the alternating-current filter capacitor without increasing the number of components.

The present disclosure has been made in view of the above, and an object of the present disclosure is to obtain a power converter capable of measuring the capacitance of an alternating-current filter capacitor without increasing the number of components.

### Means to Solve the Problem

In order to solve the above-described problem and achieve the object, a power converter according to the present disclosure includes a three-phase inverter; and a controller that controls operation of the three-phase inverter. The three-phase inverter converts input power into three-phase alternating-current power, and supplies the converted three-phase alternating-current power to a load via an alternating-current output filter, the alternating-current output filter including an alternating-current filter reactor and an alternating-current filter capacitor. The controller includes a capacitance estimator that estimates a capacitance of each phase of the alternating-current filter capacitor based on information on a three-phase voltage and information on a three-phase first current, the three-phase voltage being a voltage at each of connection points between the alternating-current filter reactor and the alternating-current filter capacitor, the three-phase first current flowing between the three-phase inverter and each of the connection points.

### Effects of the Invention

The power converter according to the present disclosure achieves an effect of enabling the capacitance of the alternating-current filter capacitor to be measured without increasing the number of components.

### BRIEF DESCRIPTION OF DRAWINGS

FIG. 1 is a diagram illustrating an exemplary configuration of a vehicle auxiliary power supply including a power converter according to a first embodiment.

FIG. 2 is a diagram illustrating a first exemplary configuration of a power supply source that generates power to be input to a three-phase inverter illustrated in FIG. 1.

FIG. 3 is a diagram illustrating a second exemplary configuration of the power supply source that generates power to be input to the three-phase inverter illustrated in FIG. 1.

FIG. 4 is a functional block diagram illustrating an exemplary configuration of a controller according to the first embodiment.

FIG. 5 is a flowchart illustrating a flow of processing to be performed by the controller according to the first embodiment.

FIG. 6 is a block diagram illustrating an exemplary hardware configuration to be adopted in a case where functions of a controller according to the first embodiment are implemented by software.

FIG. 7 is a block diagram illustrating an exemplary configuration to be adopted in a case where the functions of the controller according to the first embodiment are implemented by a control circuit.

FIG. 8 is a diagram illustrating an exemplary configuration of a vehicle auxiliary power supply including a power converter according to a second embodiment.

### DESCRIPTION OF EMBODIMENTS

Hereinafter, power converters and vehicle auxiliary power supplies according to embodiments of the present disclosure will be described in detail with reference to the accompanying drawings. Note that the embodiments to be described below are examples, and the scope of the present disclosure is not limited by the following embodiments. In addition, although a power converter to be installed on a railway vehicle will be described as an example in the following embodiments, this is not intended to exclude application to other uses. Furthermore, in the following description, electrical connection and physical connection are simply referred to as “connection” without being distinguished from each other. That is, the term “connection” refers to both a case where constituent elements are directly connected to each other and a case where constituent elements are indirectly connected to each other via another constituent element.

### First Embodiment

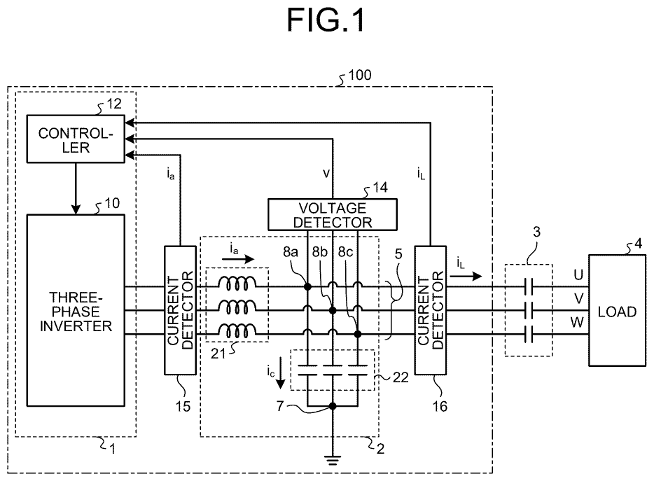

FIG. 1 is a diagram illustrating an exemplary configuration of a vehicle auxiliary power supply 100 including a power converter 1 according to a first embodiment. As illustrated in FIG. 1, the vehicle auxiliary power supply 100 according to the first embodiment includes a the power converter 1; an alternating-current output filter 2; a voltage detector 14; and current detectors 15 and 16. The power converter 1 includes a three-phase inverter 10 and a controller 12, The three-phase inverter 10 and a load 4 are connected via the alternating-current output filter 2 by use of three electric wires 5. The three electric wires 5 are “U-phase”, “V-phase”, and “W-phase” electric wires. The load 4 is to be supplied with power from the vehicle auxiliary power supply 100. The load 4 is connected to the vehicle auxiliary power supply 100 via an output contactor 3.

An example of the load 4 is an auxiliary load. The auxiliary load is a term that refers to any load to be installed on a railway vehicle, except a main motor. Examples of the auxiliary load include a vehicle interior lighting device, a door opening and closing device, an air conditioner, a safety device, a compressor, a battery, and a control power supply. Among these auxiliary loads, the vehicle interior lighting device, the door opening and closing device, the air conditioner, the safety device, and the compressor are alternating-current loads that operate by receiving supply of alternating-current power. In addition, the battery and the control power supply are direct-current loads that operate by receiving supply of direct-current power.

Returning to description of FIG. 1, the alternating-current output filter 2 includes an alternating-current filter reactor thereinafter, referred to as “ACL” as appropriate) 21 and an alternating-current filter capacitor {hereinafter, referred to as “ACC” as appropriate} 22. The ACL 21 includes three reactors. The ACC 22 includes three capacitors. Each of the three reactors in the ACL 21 is inserted into corresponding one of the U-phase, V-phase, and W-phase electric wires 5. One end of each of the three reactors is connected to the three-phase inverter 10. Other ends of the three reactors are connected to one ends of the capacitors of the ACC 22 at connection points Sa, 8b, and Sc of the electric wires 5 in one-to-one correspondence. Other ends of the three capacitors are connected to each other at one point. This connection is called a star connection. A connection point 7, which is a connection point of the star connection, is grounded. The ACL 21 and the ACC 22 form an LC alternating-current output filter.

The voltage detector 14 detects a three-phase voltage v which is a voltage at the connection points Ba, 8b, and Sc between the ACL 21 and the ACC 22. The current detector 15 detects a three-phase current is flowing between the three-phase inverter 10 and the connection points 8ₐ, 8_{b}, and 8_{c} The current detector 16 detects a three-phase current i_{L} flowing between the connection points 8a, 8h, and 8c and the load 4. Note that, in the present specification, the three-phase current i₂; may be referred to as “three-phase first current”, and the three-phase current i_{L} may be referred to as “three-phase second current”, Furthermore, in the present specification, the current detector 15 may be referred to as a “first current detector”, and the current detector 16 may be referred to as a “second current detector”.

As will be described below, a capacitor current it is obtained by calculation based on the three-phase current i₂ and the three-phase current i_{L} The capacitor current i_{c} is a current flowing through the capacitor of each phase of the ACC 22. In the drawing, arrows indicate positive directions of the three-phase current i₂ the three-phase current i_{L}, and the capacitor current i_{c}.

The voltage detector 14 and the current detectors 15 and 16 are sensors provided for controlling the three-phase inverter 10, and are not sensors newly provided so as to solve problems of the power converter 1 and the vehicle auxiliary power supply 100 according to the present disclosure. The power converter 1 and the vehicle auxiliary power supply 100 according to the present disclosure perform control and calculation to be described below by using detection values of these sensors.

Note that although the voltage detector 14 is illustrated in FIG. 1 such that the voltage detector 14 detects a voltage at the connection points 8ₐ, 8_{b}, and 8c, the configuration of the voltage detector 14 is not limited thereto. The voltage detector 14 may detect a voltage at points shifted from the illustrated connection points Ba, Sb, and Sc toward the ACL 21. In addition, the voltage detector 14 may detect a voltage at points shifted from the connection points Sa, Sb, and Sc toward the load 4, the points being located between the connection points 8a, 8_{b}, and 8_{c} and the output contactor 3. That is, the voltage detector 14 may detect the voltage of any portion as long as the portion is considered to be at the same potential as each connection point.

Under the control of the controller 12, the three-phase inverter 10 converts input power into three-phase alternating-current power, and supplies the converted three-phase alternating-current power to the load 4 via the alternating-current output filter 2, The alternating-current output filter 2 reduces harmonics included in output voltage of the three-phase inverter 10. As a result, an alternating-current voltage closer to a sinusoidal alternating-current voltage is applied to the load 4 as compared with a case where the alternating-current output filter 2 is not provided.

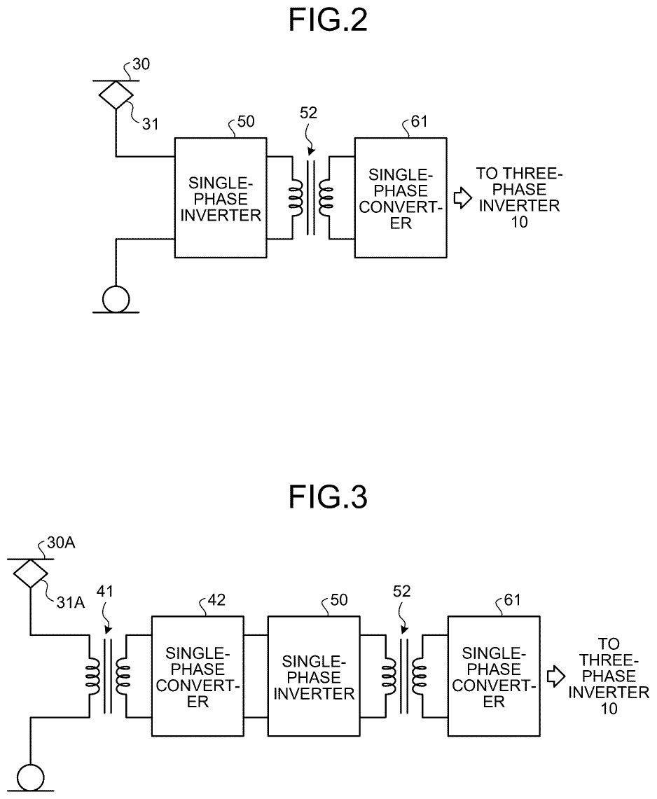

FIG. 2 is a diagram illustrating a first exemplary configuration of a power supply source that generates power to be input to the three-phase inverter 10 illustrated in FIG. 1. In the first exemplary configuration illustrated in FIG. 2, direct-current power supplied from a direct-current overhead line 30 is received via a current collector 31. The received direct-current power is converted into alternating-current power by a single-phase inverter 50. The converted alternating-current power is stepped down by a transformer 52 and supplied to a single-phase converter 61. The stepped-down alternating-current power is converted into direct-current power by the single-phase converter 61 and supplied to the three-phase inverter 10.

FIG. 3 is a diagram illustrating a second exemplary configuration of the power supply source that generates power to be input to the three-phase inverter 10 illustrated in FIG. 1. In the second exemplary configuration illustrated in FIG. 3, the direct-current overhead line 30 is replaced with an alternating-current overhead line 30A, and the current collector 31 for direct-current overhead lines is replaced with a current collector 31A for alternating-current overhead lines. Furthermore, comparing the configuration illustrated in FIG. 3 with the configuration illustrated in FIG. 2, a transformer 41 and a single-phase converter 42 are provided in this order between the current collector 31A and the single-phase inverter 50 in FIG. 3. Alternating-current power supplied from the alternating-current overhead line 30A is received by the transformer 41 via the current collector 31A. The received alternating-current power is stepped down by the transformer 41 and supplied to the single-phase converter 42. The stepped-down alternating-current power is converted into direct-current power by the single-phase converter 42 and supplied to the single-phase inverter 50. Thereafter, the same operation is performed as in the configuration illustrated in FIG. 2, Note that the single-phase inverter 50, the transformer 52, and the single-phase converter 61, which are common components, are denoted by the same reference numerals in FIGS. 2 and 3, but it goes without saying that the capacity or system of each component differs depending on a difference in overhead line voltage.

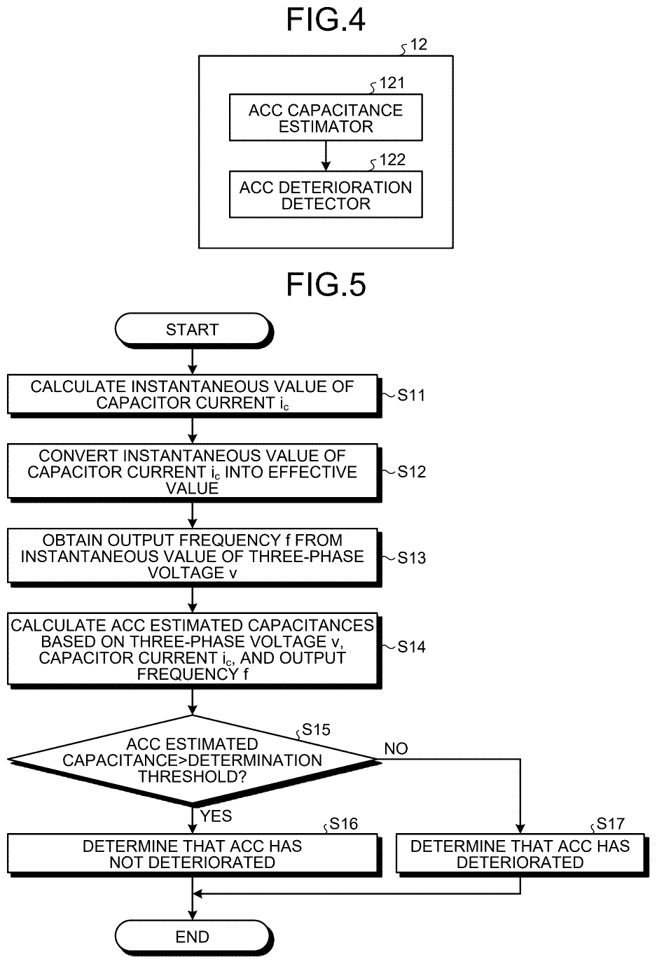

Next, the configuration and operation of the controller 12 according to the first embodiment will be described, FIG. 4 is a functional block diagram illustrating an exemplary configuration of the controller 12 according to the first embodiment. FIG. 5 is a flowchart illustrating a flow of processing to be performed by the controller 12 according to the first embodiment. As illustrated in FIG. 4, the controller 12 includes an ACC capacitance estimator 121 and an ACC deterioration detector 122. According to the flowchart of FIG. 5, the ACC capacitance estimator 121 calculates ACC estimated capacitances that are estimated values of the capacitances of the capacitors in the ACC 22. In addition, the ACC deterioration detector 122 detects a state of deterioration of the ACC 22, according to the flowchart of FIG. 5. Hereinafter, the flow of processing will be described with reference to FIG. 5. Note that the following description is based on the assumption that the vehicle auxiliary power supply 100 is in operation, and that the output contactor 3 is controlled in such a way as to be in a “closed” state.

First, the ACC capacitance estimator 121 calculates an instantaneous value of the capacitor current i_{c} by formula (1) below based on an instantaneous value of the three-phase current i₂ and an instantaneous value of the three-phase current i_{L} (step S11).

$${i}_{c} = {i}_{s} - {i}_{L} \qquad ( 1 )$$

Next, the ACC capacitance estimator 121 converts the instantaneous value of the capacitor current i_{c} into an effective value (step S12). In addition, the ACC capacitance estimator 121 obtains an output frequency f from an instantaneous value of the three-phase voltage v (step 313). The output frequency f is the frequency of a fundamental wave included in the waveform of the instantaneous value of the three-phase voltage v.

The ACC capacitance estimator 121 calculates the ACC estimated capacitances by formula (2) below based on the three-phase voltage v, the capacitor current i_{c}, and the output frequency f (step S14)

$$ACC estimated capacitance = \sqrt{} 3 {xi}_{c} / ( 2 π fv ) \qquad ( 2 )$$

Note that when the ACC estimated capacitance is obtained, it is necessary to use a phase voltage applied to both ends of the capacitor of each phase and a phase current flowing through the capacitor of each phase. In the circuit configuration of FIG. 1, the ACC 22 is star connected. Therefore, the capacitor current i_{c} to be obtained by formula (1) above is a phase current. Furthermore, in the circuit configuration of FIG. 1, the voltage detector 14 detects a line voltage. Therefore, a coefficient of 43 is added to formula (2) above, Note that the arithmetic processing of formulas (1) and (2) above is performed in each of the U, V, and W phases.

Information on the ACC estimated capacitance for each phase obtained by formula (2) above is passed to the ACC deterioration detector 122. The ACC deterioration detector 122 compares the ACC estimated capacitance with a determination threshold for each phase (step S15). When the ACC estimated capacitance of at least one of all the capacitors in the ACC 22 is larger than the determination threshold (step S15, Yes), the ACC deterioration detector 122 determines that the ACC 22 has not deteriorated (step S16). Meanwhile, when the ACC estimated capacitance of the at least one of the capacitors in the ACC 22 is equal to or less than the determination threshold (step 615, No), the ACC deterioration detector 122 determines that the ACC 22 has deteriorated (step 317).

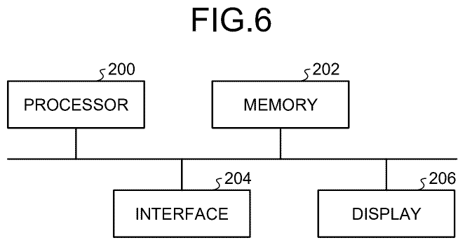

FIG. 6 is a block diagram illustrating an exemplary hardware configuration to be adopted in a case where functions of the controller 12 according to the first embodiment are implemented by software. In a case where the functions of the controller 12 according to the first embodiment are implemented by software, the controller 12 may be configured such that the controller 12 includes a processor 200, a memory 202, an interface 204, and a display 206, as illustrated in FIG. QL The processor 200 performs calculation. A program and threshold data to be read by the processor 200 are stored in and read from the memory 202. The interface 204 implements input and output of signals. The display 206 displays detection results.

The processor 200 exemplifies an arithmetic means such as an arithmetic unit, a microprocessor, a microcomputer, a central processing unit (CPU), or a digital signal processor (DSP); Furthermore, examples of the memory 202 include nonvolatile or volatile semiconductor memories such as a random-access memory (RAM), a read only memory (ROM) a flash memory, an erasable programmable ROM (EPROM, and an electrically EPROM (EEPROM (registered trademark)), a magnetic disk, a flexible disk, an optical disk, a compact disk, a mini disk, and a digital versatile disc (DVD).

The processor 200 transmits and receives necessary information via the interface 204, executes the program stored in the memory 202, and refers to the threshold data stored in the memory 202. Thus, the processor 200 can perform the processing described above. A result of computation performed by the processor 200 can be stored in the memory 202. Furthermore, results of processing performed by the processor 200 can also be displayed on the display 206. Specifically, the display 206 displays the ACC estimated capacitances described above; and results of determination by the ACC deterioration detector 122.

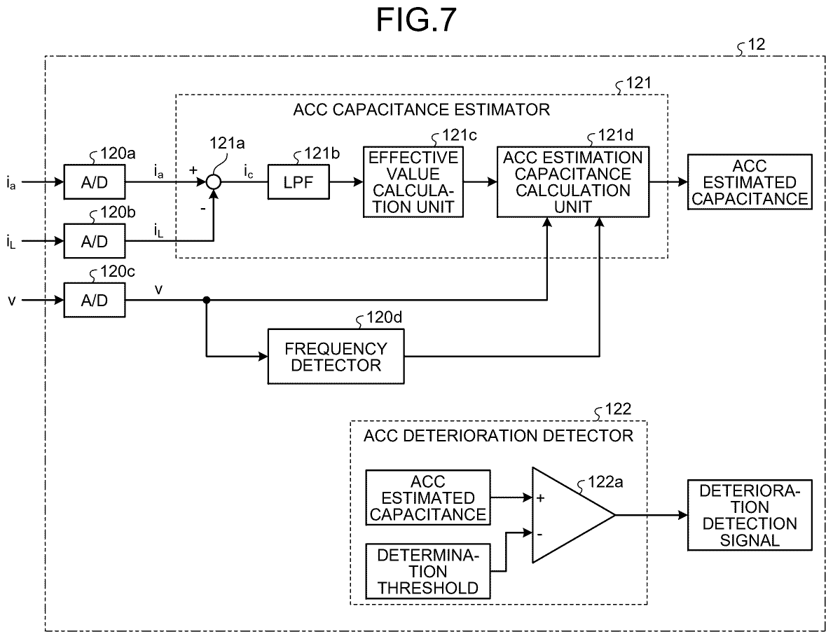

FIG. 7 is a block diagram illustrating an exemplary configuration to be adopted in a case where the functions of the controller 12 according to the first embodiment are implemented by a control circuit. The controller 12 includes s analog to digital (hereinafter referred to as “A/D”) converters 120a, 120b, and 120c; and a frequency detector 120d, in addition to the ACC capacitance estimator 121 and the ACC deterioration detector 122 illustrated in FIG. 4t

The ACC capacitance estimator 121 includes r an adder-subtracter 121a; a low-pass filter (LPF) 121b; an effective value calculation unit 121c, and an ACC estimated capacitance calculation unit 121d. The ACC deterioration detector 122 includes a comparator 122a.

An instantaneous value of the three-phase current i₂ an instantaneous value of the three-phase current i_{L}, and an instantaneous value of the three-phase voltage v are input to the controller 12. These instantaneous values are converted into digital values by the A/D converters 120a, 120b, and 120c Hereinafter, for convenience of description, the same symbols are used for the digital values, and the same names are used without making a distinction between an analog signal and a digital value.

Outputs of the A/D converters 120a and 120b are input to the adder-subtracter 121a. An output of the A/D converter 120c is input to the ACC estimated capacitance calculation unit 121d and the frequency detector 120d. An output of the adder-subtracter 121a is input to the effective value calculation unit. 121c after being passed through the low-pass filter 121b. An output of the effective value calculation unit 121c and an output of the frequency detector 120d are input to the ACC estimated capacitance calculation unit 121d.

The processing to be performed by the adder-subtracter 121a corresponds to the processing in step S11 in FIG. 5. An instantaneous value of the capacitor current i_{c} is output from the adder-subtracter 121a. The processing to be performed by the effective value 30 calculation unit 121c corresponds to the processing in step S12 in FIG. 5. The instantaneous value of the three-phase current i₂ to be used in the arithmetic processing in step 311 contains a lot of harmonics associated with switching operation of the three-phase inverter 10. Therefore, prior to the effective value calculation unit 121c obtains an effective value, a process of reducing harmonics is performed by the low-pass filter 121b.

The processing to be performed by the frequency detector 120d corresponds to the processing in step 313 in FIG. 5. Note that, as described above, the instantaneous value of the three-phase current i₂ contains a lot of harmonics, and accordingly, the three-phase voltage v also contains harmonics, Therefore, it is desirable to perform filter processing for reducing harmonics inside the frequency detector 120d.

The processing to be performed by the ACC estimated capacitance calculation unit 121d corresponds to the processing in step 614 in FIG. 5. Furthermore, the processing to be performed by the comparator 122a in the ACC deterioration detector 122 corresponds to the processing in steps S15 to 617 in FIG. 5. An output of the comparator 122a can be used as a deterioration detection signal, Note that the ACC deterioration detector 122 includes a single comparator 122a in the configuration of FIG. 7, but the configuration of the ACC deterioration detector 122 is not limited to this configuration. The ACC deterioration detector 122 may include a plurality of comparators. Use of a plurality of comparators and a plurality of determination thresholds enables the degree of deterioration of the ACC 22 to be determined at multiple levels. This makes it possible to encourage replacement of the alternating-current output filter 2 before the alternating-current output filter 2 fails. When the vehicle auxiliary power supply 100 according to the first embodiment is installed in a railway vehicle system, it is possible to suppress a decrease in the operation rate of the railway vehicle system.

As described above, according to the first embodiment, the controller includes the capacitance estimator that estimates the capacitance of each phase of the alternating-current filter capacitor based on: information on the three-phase voltage; information on the three-phase first current; and information on the three-phase second current. The three-phase voltage is a voltage at each of connection points between the alternating-current filter reactor and the alternating-current filter capacitor. The three-phase first current flows between the three-phase inverter and each of the connection points. The three-phase second current flows between each of the connection points and the load. Information on each of the three-phase voltage, the three-phase first current, and the three-phase second current is detected by an existing sensor. Therefore, it is not necessary to provide a new sensor. As a result, it is possible to obtain an effect of enabling the capacitance of the alternating-current filter capacitor to be measured without, increasing the number of components.

In addition, according to the first embodiment, in a state where the output contactor is closed, the capacitance estimator, calculates a capacitor current based on the three-phase first current and the three-phase second current, the capacitor current flowing through the capacitor of each phase included in the alternating-current filter capacitor; and also calculates an estimated value of the capacitance based on the capacitor current, the three-phase voltage, and an output frequency of the three-phase voltage. As a result, it is possible to obtain an effect of enabling the state of deterioration of the alternating-current filter capacitor to be visualized.

Furthermore, in the first embodiment, the controller includes the deterioration detector that detects the state of deterioration of the alternating-current filter capacitor based on an estimated value of the capacitance estimated by the capacitance estimator. As a result, when deterioration of the alternating-current filter capacitor progresses, an alarm signal can be output to an operator or an administrator, so that it is possible to obtain an effect of facilitating the work of maintaining devices.

### Second Embodiment

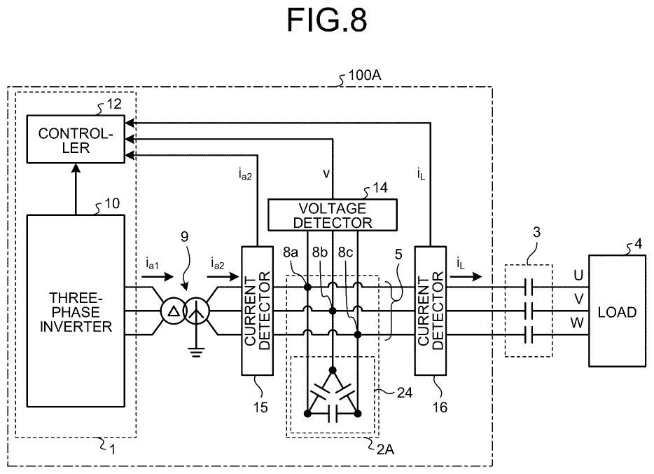

FIG. 8 is a diagram illustrating an exemplary configuration of a vehicle auxiliary power supply 100A including the power converter 1 according to a second embodiment. In FIG. 8, as compared with the configuration of the vehicle auxiliary power supply 100 illustrated in FIG. 1, the alternating-current output filter 2 is replaced with an alternating-current output filter 2A, and a transformer 9 is inserted on an output side of the three-phase inverter 10. The alternating-current output filter 2A includes a delta-connected ACC 24. The ACC 24 is connected to a secondary side of the transformer 9. Windings on a primary side of the transformer 9 are delta-connected, and windings on the secondary side of the transformer 9 are star-connected and a neutral point thereof is grounded. Except for the above, the configuration of the vehicle auxiliary power supply 100A is the same as or equivalent to the configuration of the vehicle auxiliary power supply 100 illustrated in FIG. 1. Thus, the same or equivalent components are denoted by the same reference numerals, and redundant description is omitted.

Next, the configuration and operation of the controller 12 according to the second embodiment will be described. The basic operation thereof is similar to that in the first embodiment, and only the difference will be described here.

The controller 12 according to the second embodiment calculates an instantaneous value of the capacitor current i_{c} by formula (3) below.

$${i}_{c} = {i}_{s 2} - {i}_{L} \qquad ( 3 )$$

In formula (3) above, “iₐ₂” denotes a secondary current flowing on the secondary side of the transformer 9. The secondary current i₂₂ is detected by the current detector 15. The current detector 15 may be configured such that the current detector 15 detects a primary current i₂₁ flowing on the primary side of the transformer 9. In this configuration, it, is possible to obtain the secondary current i₂₂ by converting a detection value of the primary current i₂₁ at a transformation ratio of the transformer 9. Therefore, it is possible to use either of these currents, that is, the primary current i₂₁ and the secondary current i₂₂, as the three-phase first current referred to herein.

In addition, the controller 12 according to the second embodiment calculates the ACC estimated capacitance by formula (3) above and formula (4) below

$$ACC estimated capacitance = ( 1 / \sqrt{} 3 ) {xi}_{c} / ( 2 π fv ) \qquad ( 4 )$$

As described above, when the ACC estimated capacitance is obtained, it is necessary to use the phase voltage at the capacitor of each phase and the phase current flowing through the capacitor of each phase. In the circuit configuration of FIG. 8, the ACC 24 is delta-connected, thus the capacitor current i_{c} obtained by formula (3) above is a line current. Furthermore, the voltage detector 14 detects a line voltage in the circuit configuration of FIG. 8. Therefore, a, coefficient of (1/√3) is added to formula (4) above, Note that the arithmetic processing of formulas (3) and (4) above is performed in each of the U, V, and W phases.

Hereinafter, a determination process and a detection process regarding the state of deterioration of the ACC 24 are performed according to the flowchart of FIG. 5. Alternatively, the determination process and the detection process may be performed by the control circuit of FIG. 7, instead of being performed according to the flowchart of FIG. 5.

As described above, according to the second embodiment, the controller includes the capacitance estimator that estimates the capacitance of each phase of the alternating-current filter capacitor based on information on the three-phase voltage; information on the three-phase first current; and information on the three-phase second current. The three-phase voltage is a voltage at each of connection points between the alternating-current filter reactor and the alternating-current filter capacitors. The three-phase first current flows between the three-phase inverter and the primary side of the transformer or between the secondary side of the transformer and each of the connection points. The three-phase second current flows between each of the connection points and the load. Information on each of the three-phase voltage, the three-phase first current, and the three-phase second current is detected by an existing sensor. Therefore, it is not necessary to provide a new sensor. As a result, it is possible to obtain an effect of enabling the capacitance of the alternating-current filter capacitor to be measured without increasing the number of components.

In addition, according to the second embodiment, in a state where the output contactor is closed, the capacitance estimators calculates a capacitor current flowing through the capacitor of each phase included in the alternating-current filter capacitor based on the three-phase first current and the three-phase second current; and also calculates an estimated value of the capacitance based on the capacitor current, the three-phase voltage, and an output frequency of the three-phase voltage. As a result, it is possible to obtain an effect of enabling the state of deterioration of the alternating-current filter capacitor to be visualized.

Furthermore, in the second embodiment, the controller includes the deterioration detector that detects the state of deterioration of the alternating-current filter capacitor based on an estimated value of the capacitance estimated by the capacitance estimator. As a result, when deterioration of the alternating-current filter capacitor progresses, an alarm signal can be output to an operator or an administrator, so that it is possible to obtain an effect of facilitating the work of maintaining devices.

### Third Embodiment

The methods for calculating ACC estimated capacitances in a state where the output contactor 3 is “closed” have been described in the first and second embodiments. Meanwhile, a method for calculating ACC estimated capacitances in a state where the output contactor 3 is “open” will be described in a third embodiment.

The ACC capacitance estimator 121 calculates an instantaneous value of the capacitor current i_{c} by formula (5) below based on an instantaneous value of the three-phase current i₂.

A supplementary description of formula (5) above will be given as follows. Since the output contactor 3 is in an “open” state, no current flows through the load 4. Therefore, the three-phase current i_{L} also becomes zero. Thus, formula (S) above is established.

The same processing as that in the first and second embodiments is performed thereafter. Therefore, in the case of the first embodiment, that is, the configuration of FIG. 1, the ACC estimated capacitances are calculated based on formula (2) above. Furthermore, in the case of the second embodiment, that is, the configuration of FIG. 8, the ACC estimated capacitances are calculated based on formula (4) above. Moreover, a state of deterioration of the alternating-current filter capacitor is detected based on the calculated ACC estimated capacitances.

Note that the processing according to the third embodiment can be implemented in the vehicle auxiliary power supplies 100 and 100A in a test mode or an inspection mode. With this configuration, it is possible to continuously grasp the state of deterioration of the alternating-current filter capacitor by daily inspection or the like.

As described above, according to the third embodiment, the controller includes the capacitance estimator that estimates the capacitance of each phase of the alternating-current filter capacitor based on information on the three-phase voltage and information on the three-phase first current, the three-phase voltage being a voltage at each of connection points between the alternating-current filter reactor and the alternating-current filter capacitor, the three-phase first current flowing between the three-phase inverter and each of the connection points. Information on each of the three-phase voltage and the three-phase first current is detected by an existing sensor. Therefore, it is not necessary to provide a new sensor. As a result, it is possible to obtain an effect of enabling the capacitance of the alternating-current filter capacitor to be measured without increasing the number of components.

In addition, according to the third embodiment, in a state where the output contactor is open, the capacitance estimator, calculates a capacitor current based on the three-phase first current, the capacitor current flowing through the capacitor of each phase included in the alternating-current filter capacitor; and also calculates an estimated value of the capacitance based on the capacitor current, the three-phase voltage, and an output frequency of the three-phase voltage. As a result, it is possible to obtain an effect of enabling the state of deterioration of the alternating-current filter capacitor to be visualized.

Furthermore, in the third embodiment, the controller includes the deterioration detector that detects the state of deterioration of the alternating-current filter capacitor based on an estimated value of the capacitance estimated by the capacitance estimator. As a result, when deterioration of the alternating-current filter capacitor progresses, an alarm signal can be output to an operator or an administrator, so that it is possible to obtain an effect of facilitating the work of maintaining devices.

In addition, the method of the third embodiment may be incorporated in the vehicle auxiliary power supply so as to enable the method to be implemented in the test mode or the inspection mode. According to the vehicle auxiliary power supply configured as described above, it is possible to obtain an effect of enabling the state of deterioration of the alternating-current filter capacitor to be continuously grasped by daily inspection or the like.

The configurations set forth in the above embodiments show examples, and it is possible to combine the configurations with another known technique or combine the embodiments with each other, and is also possible to partially omit or change the configurations without departing from the scope of the present disclosure.

### REFERENCE SIGNS LIST

1 power converter; 2, 2A alternating-current output filter; 3 output contactor; 4 load; 5 electric wire; 7, Ba, 8b, Sc connection point; 9, 41, 52 transformer; 10 three-phase inverter; 12 controller; 14 voltage detector; 15, 16 current detector; 21 alternating-current filter reactor; 22, 24 alternating-current filter capacitor; 30 direct-current overhead line; 30A alternating-current overhead line; 31, 31A current collector; 42, 61 single-phase converter; 50 single-phase inverter; 100, 110A vehicle auxiliary power supply; 120a, 120b, 120c A/D converter; 120d frequency detector; 121 ACC capacitance estimator; 121a adder-subtracter; 121b low-pass filter; 121c effective value calculation unit; 121d ACC estimated capacitance calculation unit; 122 ACC deterioration detector; 122a comparator; 200 processor; 202 memory; 204 interface; 206 display.

1. A power converter comprising:
a three-phase inverter configured to convert input power into three-phase alternating-current power and supply the converted three-phase alternating-current power to a load via an alternating-current output filter, the alternating-current output filter including an alternating-current filter reactor and an alternating-current filter capacitor; and
a controller configured to control operation of the three-phase inverter, wherein
the controller includes a capacitance estimator configured to estimate a capacitance of each phase of the alternating-current filter capacitor based on:
information on a three-phase voltage that is a voltage at each of connection points between the alternating-current filter reactor and the alternating-current filter capacitor; and
information on a three-phase first current flowing between the three-phase inverter and each of the connection points.

2. The power converter according to claim 1, wherein
an output contactor is provided between the three-phase inverter and the load, and
in a state where the output contactor is open, the capacitance estimator is configured to calculate an estimated value of the capacitance based on the three-phase first current, the three-phase voltage, and an output frequency of the three-phase voltage.

3. The power converter according to claim 1, wherein
the controller includes a deterioration detector configured to detect a state of deterioration of the alternating-current filter capacitor based on an estimated value of the capacitance estimated by the capacitance estimator.

4. The power converter according to claim 1, wherein
the output contactor is provided between the three-phase inverter and the load,
information on a three-phase second current flowing between each of the connection points and the load is input to the capacitance estimator, and
in a state where the output contactor is closed, the capacitance estimator:
is configured to calculate a capacitor current based on the three-phase first current and the three-phase second current, the capacitor current flowing through a capacitor of each phase included in the alternating-current filter capacitor; and
is configured to calculate an estimated value of the capacitance based on the capacitor current, the three-phase voltage, and an output frequency of the three-phase voltage.

5. The power converter according to claim 4, wherein
the controller includes a deterioration detector configured to detect a state of deterioration of the alternating-current filter capacitor based on an estimated value of the capacitance estimated by the capacitance estimator.

6. A vehicle auxiliary power supply to be installed on a railway vehicle, the vehicle auxiliary power supply comprising:
the power converter according to claim 1;
the alternating-current output filter;
a voltage detector configured to detect the three-phase voltage; and
a first current detector configured to detect the three-phase first current, wherein
the three-phase alternating-current power is supplied to an auxiliary load by use of direct-current power or alternating-current power supplied through an overhead line, the auxiliary load being the load other than a main motor.

7. A vehicle auxiliary power supply to be installed on a railway vehicle, the vehicle auxiliary power supply comprising:
the power converter according to claim 4;
the alternating-current output filter;
a voltage detector configured to detect the three-phase voltage;
a first current detector configured to detect the three-phase first current; and
a second current detector configured to detect the three-phase second current, wherein
the three-phase alternating-current power is supplied to an auxiliary load by use of direct-current power or alternating-current power supplied through an overhead line, the auxiliary load being the load other than a main motor.

8. The vehicle auxiliary power supply according to claim 6, wherein
the alternating-current filter reactor is connected to each output end of the three-phase inverter, and
the alternating-current filter capacitor is Y-connected at an end of the alternating-current filter reactor, the end being located closer to the load.

9. The vehicle auxiliary power supply according to claim 7, comprising:
a transformer including primary windings and secondary windings, the primary windings being connected to respective output ends of the three-phase inverter, wherein
the alternating-current filter capacitor is delta-connected and connected to respective output ends of the secondary windings of the transformer.

10. The vehicle auxiliary power supply according to claim 8, comprising:
a transformer including primary windings and secondary windings, the primary windings being connected to respective output ends of the three-phase inverter, wherein
the alternating-current filter capacitor is delta-connected and connected to respective output ends of the secondary windings of the transformer.
